(19) United States
(12) Patent Application Publication
(10) Pub. No.: US 2009/0096373 A1
(43) Pub. Date: Apr. 16, 2009

(54) Glass-supported electroluminescent nixels and elements with single-sided electrical contacts

(76) Inventors: Adrian H. Kitai, Mississauga (CA); Guo Liu, Brampton, CA (US)

Correspondence Address: Ralph A. Dowell of DOWELL & DOWELL P.C., 2111 Eisenhower Ave, Suite 406, Alexandria, VA, 22314, US

(21) Appl. No.: 11/907,702

(22) Filed: Oct. 16, 2007

(51) Int. Cl. H01J 1/62; H01J 9/02

(52) U.S. Cl. 313/509; 445/24

(57) ABSTRACT

Systems and methods are provided for electroluminescent display elements which are glass supported. These electroluminescent display elements include an EL element or nixel structure that makes use of two rear or substantially same-sided electrodes that are electrically separated by a small gap or other non-conductive (e.g., insulating) material, but that generally cover the rear area of the EL element or nixel laminate. This EL element has a glass plate applied on the other side of the EL element. These EL elements may be made by growing the layers one on top of the other on one side on the glass plate, or a free standing EL element may be made using a ceramic substrate having a front surface onto which the layers are deposited. The back surface of the ceramic substrate may then be ground down to be thinner and the two back electrodes applied to this back surface, after which a glass plate is applied to the other side of the element.

### FIELD OF INVENTION

This invention relates generally to electroluminescent (EL) displays, and more particularly, to displays composed of individually produced EL elements or nixels each having electrical contacts on the same side of the EL element or nixels with the nixels being fabricated with glass plates to provide mechanical support.

### BACKGROUND OF INVENTION

Electroluminescence (EL), a well-known phenomenon commonly exploited in flat panel displays, is the conversion of electrical energy to light via the application of an electrical field to a phosphor. Commonly used EL devices include Light Emitting Diodes (LEDs), laser diodes, and EL displays (ELDs). Typically, an ELD is in the form of a thin film electroluminescent (TFEL) device, which is a solid-state device generally comprising a phosphor layer positioned between two dielectric layers, and further including an electrode layer on the surface of each dielectric layer to form a five-layer structure, where the electrode layers define the outer layers and the phosphor layer defines the inner middle layer.

Co-pending U.S. application Ser. No. 11/526,661, filed Sep. 26, 2006, and entitled Electroluminescent Apparatus and Display Incorporating Same, which is incorporated herein in its entirety by reference, discloses electroluminescent (EL) nixels (pixel devices) that are individually produced such that EL displays may be produced by assembling as many of the individual nixels as required. The electroluminescent (EL) nixels generally include a laminate of a rear electrode, a first dielectric layer, an EL phosphor layer, a second dielectric layer, and a front electrode. At least one of these two electrodes needs to be transparent for light to escape the display device.

In each of the above-described structures, electrical connections to these EL nixels must be made between the front electrodes and the rear electrodes. However, in some applications, electrical connections to the front (emissive) electrodes are difficult to make because such electrical connections interfere with EL emission from the front electrodes. Further, the front electrode electrical connections require yet another processing step that may introduce additional errors during production. Co-pending U.S. patent application Ser. No. 11/683,489 Filed Mar. 8, 2007 and entitled ELECTROLUMINESCENT NIXELS AND ELEMENTS WITH SINGLE-SIDED ELECTRICAL CONTACTS provides nixel structures having single-sided electrode connections.

A drawback to these single sided nixel structures is that for mechanical support they require a thick ceramic dielectric layer, whereas thinner dielectric layers are usually accompanied by higher brightness, lower power consumption, lower operating voltages and ease of fabrication of highly uniform layers. Thus it would be desirable to provide a nixel structure which enables the use of thinner ceramic or glass dielectric layers yet still has the necessary mechanical strength and more uniform display and better greyscale.

### SUMMARY OF INVENTION

The systems and methods of the present invention produce an individually sized and shaped modular EL element or chip which is supported by glass substrates. According to an embodiment of the invention, these EL elements may be “nixels” as illustratively described herein, which are individually sized and modular shaped EL elements that are adapted to form part of an integrated ELD having multiple electrical contacts on the same side of the EL element structure.

More particularly the present invention provides an EL element or nixel structure that makes use of two rear or substantially same-sided electrodes that are electrically separated by a small gap or other non-conductive (e.g., insulating) material, but that generally cover the rear area of the EL element or nixel laminate. These two electrodes may generally be equal in area and each cover approximately half the EL element or nixel area, according to an embodiment of the invention. A glass plate is applied to the other side of the EL element.

An embodiment of an electroluminescent display element comprises at least two light emitting regions, each of said at least two light emitting regions including a dielectric layer having an upper surface and a lower surface; a top conductive layer having an upper surface and a lower surface, wherein the top conductive layer and the dielectric layer are positioned opposite one another so that the lower surface of the top conductive layer faces the upper surface of the dielectric layer; a phosphor layer, wherein the phosphor layer is arranged between, and is in physical contact with, the dielectric layer and the top conductive layer; a bottom conductive layer having an upper surface and a lower surface, wherein the bottom conductive layer and the dielectric layer are positioned opposite one another so that the upper surface of the bottom conductive layer faces, and is in physical contact with, the lower surface of the dielectric layer, and wherein the bottom conductive layer forms a first bottom electrode and a second bottom electrode; wherein one of said phosphor layers in one of said at least two pixels emits in one of a red, green or blue region of the visible light spectrum, and the other of said phosphor layers emits in a different region of the visible light spectrum; and said at least two pixels mounted on a single glass plate with a surface of the glass plate in physical contact with the upper surface of the top conductive layer of both pixels.

The aforementioned electroluminescent display element may include a layer of a bonding agent located between the glass slide and the at least two light emitting regions for bonding the at least two light emitting regions to said glass plate when the EL element is fabricated using a free standing EL chip.

The present invention provides a method for fabricating an electroluminescent display element, comprising the steps of: An electroluminescent display element, comprising:

at least two light emitting regions, each of said at least two light emitting regions including

a dielectric layer having an upper surface and a lower surface;

a top conductive layer having an upper surface and a lower surface, wherein the top conductive layer and the dielectric layer are positioned opposite one another so that the lower surface of the top conductive layer faces the upper surface of the dielectric layer;

a phosphor layer, wherein the phosphor layer is arranged between, and is in physical contact with, the dielectric layer and the top conductive layer;

a bottom conductive layer having an upper surface and a lower surface, wherein the bottom conductive layer and the dielectric layer are positioned opposite one another so that the upper surface of the bottom conductive layer faces, and is in physical contact with, the lower surface of the dielectric layer, and wherein the bottom conductive layer forms a first bottom electrode and a second bottom electrode; and

said at least two light emitting regions mounted on a single glass plate with a lower surface of the glass plate in physical contact with the upper surface of the top conductive layer of all of said at least two light emitting regions.

The present invention provides a method for fabricating an electroluminescent display element, comprising the steps of: a) providing a glass plate having an upper surface and a lower surface; b) depositing an upper conductive layer on the lower surface of the glass plate; c) depositing a phosphor layer over the upper conductive layer; d) depositing a dielectric layer over the phosphor layer; e) depositing a bottom conductive layer on a lower surface of the dielectric layer wherein the bottom conductive layer forms a first bottom electrode and a second bottom electrode.

A further understanding of the functional and advantageous aspects of the invention can be realized by reference to the following detailed description and accompanying drawings.

### BRIEF DESCRIPTION OF THE DRAWINGS

The invention will be more fully understood from the following detailed description thereof taken in connection with the accompanying drawings, which form part of this application, and in which:

FIG. 1 illustrates a side view of a partially disassembled modular EL chip (also referred to as an EL element or nixel chip) with two single-sided electrical contacts in which the EL chip is first fabricated and then a top glass plate is cemented to the top surface opposite to the surface to which the electrical contacts are applied;

FIG. 2 illustrates an assembled view of the EL chip of FIG. 1, but FIG. 2 may also represent an assembled view of a modular EL chip formed layer by layer on the bottom surface of the top glass plate; and

FIG. 3 illustrates an EL chip including three (3) different colored phosphors, red, green and blue applied to form a complete RGB pixel.

### DETAILED DESCRIPTION OF EXEMPLARY EMBODIMENTS

In general, the systems, methods, and apparatuses presented herein are directed to an individually formed, modular electroluminescent (EL) element or chip. According to an embodiment of the invention, these EL elements may be “nixels” as illustratively described herein, which are individually sized and modular shaped EL elements that are adapted to form part of an integrated ELD having multiple electrical contacts on the same side of the EL element structure.

As used herein, the term “module” may refer to a self-contained component of a system, which has a well-defined interface to the other components. Typically something is modular if it includes or uses modules which can be interchanged as units without disassembly of the module. Design, manufacture, repair, etc. of the modules may be complex, but this is not relevant; once the module exists, it can easily be connected to or disconnected from the system.

As required, specific embodiments of the invention are disclosed herein. It should be understood, however, that these are merely exemplary embodiments of the invention that can be variably practiced. Drawings are included to assist the teaching of the invention to one skilled in the art; however, they are not drawn to scale and may include features that are either exaggerated or minimized to better illustrate particular elements of the invention. Related elements may be omitted to better emphasize the novel aspects of the invention. Specific structural and functional details disclosed herein are not to be interpreted as limiting, but merely as a basis for the claims and as a representative basis for teaching one skilled in the art to variously employ embodiments of the invention.

As used herein, the term “about”, when used in conjunction with ranges of dimensions such as thicknesses of layers or other physical properties or characteristics, is meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

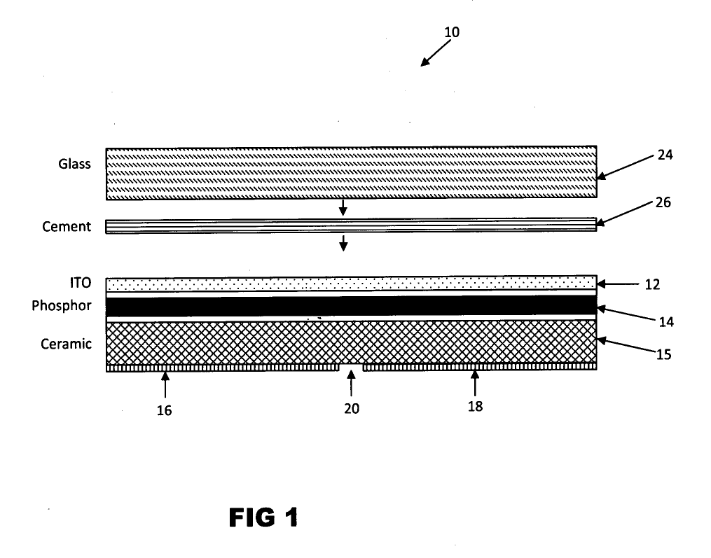

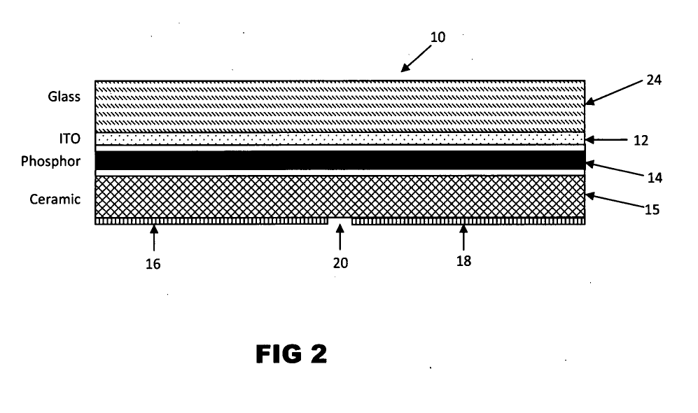

According to an exemplary embodiment of the invention, FIG. 1 illustrates a side view of a partially disassembled modular EL chip 10 (e.g., an EL element or nixel chip) with two single-sided electrical contacts (e.g., electrodes) while FIG. 2 illustrates an assembled view of the EL chip 10 of FIG. 1. FIG. 2 may also represent an assembled view of a modular EL chip formed layer by layer on the glass substrate 24. More specifically, the EL chip 10 includes an EL phosphor layer 14 deposited on a dielectric layer 15. A conductive layer 12 and the two bottom electrode layers 16, 18 sandwich the EL phosphor layer 14 and the dielectric layer 15. The two bottom electrode layers 16, 18 may be electrically separated from each other by a gap 20 or other non-conductive material. While not illustrated, a charge injection layer may be provided between the EL phosphor layer 14 and the dielectric layer 15, or between the EL phosphor layer 14 and the top conductive layer 12 shown as indium tin oxide (ITO), or a charge injection layer may be present between both. A thin glass layer 24 is bonded to the top surface of the conducting electrode 12 by a cement layer 26.

In an embodiment of a method of producing EL chip 10, the glass sheet 24 is bonded to the top surface of the ITO layer 12 using thin bonding layer 26 (such as epoxy) between glass 24 and ITO layer 12. The glass 24 is bonded to the ITO layer 12 after the ITO is deposited, but before back electrodes 16 and 18 are deposited. After glass layer 24 is bonded to the ITO layer 12, the dielectric layer 15 is then ground down to the desired thickness. After the ceramic layer 15 has been ground to the desired thickness, the back electrodes 16 and 18 are added to the bottom surface of the dielectric layer 15. Large sheets of EL chip 10 can then be cut into pixel size pieces with two back contacts each as shown in FIGS. 1 and 2. In other words large sheets may be produced with the cross section of FIGS. 1 and 2 and it is then cut into individual EL chips 10 as shown.

The structure of EL chip 10 exhibits several significant advantages over previous designs. First, the thinner dielectric layer 15 enables higher brightness to be achieved with EL chip 10. Because it is ground down to a desirable thickness, it has a uniform dielectric thickness, consequently the chip 10 is characterized by a more uniform display and better greyscale. The glass layer 24 provides a seal for phosphor layer 14. Finally, the glass plate 24 gives a mechanically stronger EL chip 10.

In addition, glass plates 24 with thicknesses from 50 microns are available at a low cost and it may be cut using a dicing saw, or alternatively it may be laser cut or score cut. The glass has a high quality surface finish, has good dimensional accuracy and is stronger than BaTiO₃ for example.

In another embodiment of a method of producing EL chip 10, one can use the glass plate 24 to support all the other layers. For example, the ITO layer 12 can be directly vacuum deposited onto the bottom surface of glass 24, followed by deposition of the phosphor layer 14 onto the bottom surface of the ITO layer 12. The dielectric layer 15 is then deposited onto the bottom layer of the phosphor layer 14, after which the rear electrodes 16 and 18 are deposited onto the bottom surface of dielectric layer 15.

This method has several advantages including elimination of the need for bonding (or cement) layer 26 thereby allowing more light to exit the EL chip 10 through glass layer 24, there is no need for the ceramic grind and polish steps in the first method discussed above. In addition, the EL phosphors 14 are independent of the dielectric 15 smoothness and purity and the phosphor layer growth process does not damage the dielectric layer 15.

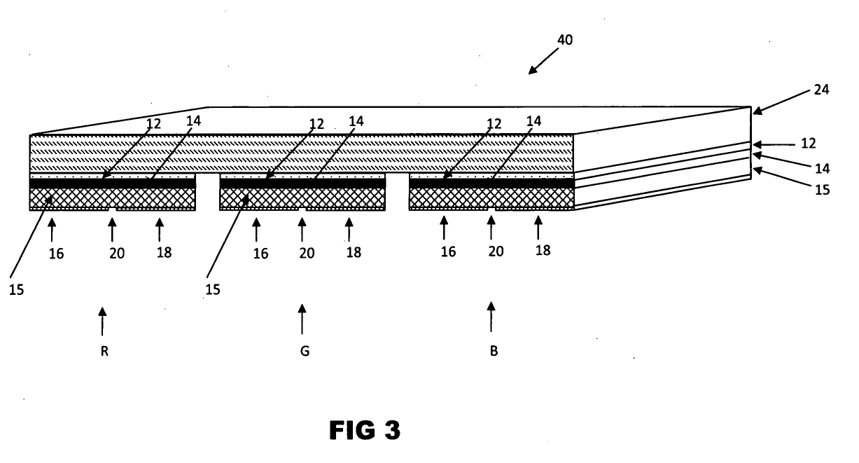

Referring to FIG. 3, more than one phosphor layer (color) may be applied to glass sheet 24. For example, an EL chip 40 includes three (3) different colored phosphors, red 42, green 44 and blue 46 applied to form a complete RGB pixel.

In an embodiment of the glass supported nixels disclosed herein, the nixel is fabricated from free standing ceramic (dielectric) substrates which are then glued onto the glass slide. In this case the ceramic substrate typically has a thickness in a range from about 50 to about 200 microns and is a high K ceramic substrate, with a thin film phosphor and electrode layers as in FIG. 1. The glass thickness may be in a range from about 50 to about 1000 microns. An advantage of a thick ceramic substrate is that it reduces or prevents electrical breakdown.

In the embodiment of the glass supported nixels grown on the glass plate 24, the thickness of the glass may be in a range from about 500 to about 1100 microns, since the glass slide needs to be strong enough to go through all the thin film processing steps. The ceramic or glass dielectric layer 15 is in the range of 0.2 microns to 50 microns. The advantage in this case is that dielectric layer 15 is generally thinner than in the embodiment of the nixel as a whole being glued onto the glass plate, and the dielectric layer 15 may be grown by thin film techniques such as sputtering, or thick film techniques such as screen printing. This can lower costs, increase uniformity and drop the operating voltage and power to produce a more efficient display.

Still referring to FIGS. 1 and 2, it will be appreciated that the conductive layer 12 may be a transparent conductive material such as indium tin oxide (ITO) as shown. However, other flexible, transparent conductive materials may be utilized for the top conductive layer 12, including PEDOT (Poly(3,4-ethylenedioxythiophene), such as H. C. Starck's Baytron®, inherently conductive polymers (ICP), substantially transparent organic or inorganic films, or substantially transparent nano-structure-based (e.g., carbon nanotube, silver nanofiber) conductive films. It will be appreciated that some of the above-noted materials, such as for example PEDOT (Poly(3,4-ethylenedioxythiophene), would only be used if the pre-formed nixel is glued to glass and could not be used if the pixel is grown on glass since the PEDOT could not handle the phosphor growth conditions.

Similarly, the two bottom electrode layers 16, 18 may comprise any of the conductive materials above, or yet other conductive materials, including gold, silver, aluminum, nickel, copper, chromium, steel, platinum, alloys, a combination thereof, and the like.

According to an embodiment of the invention, the dielectric layer 15 may be a ceramic dielectric layer. The ceramic dielectric layer 15 may be composed of barium titanate, BaTiO₃ (BT) or barium strontium titanate, Ba_{0.5}Sr_{0.5}TiO₃ (BST). It will be appreciated that other materials may be used for the dielectric layer 15, including glass, metal oxides, or other dielectric material. The EL phosphor layer 14 may include metal oxide phosphors and sulfide phosphors. Such metal oxide phosphors and methods of production are described in U.S. Pat. Nos. 5,725,801; 5,897,812; 5,788,882 and U.S. patent application Ser. No. 10/552,452, which patents and application are herein incorporated by reference. Metal oxide phosphors include: Zn₂Si_{0.5}Ge_{0.5}O₄:Mn, Zn₂SiO₄:Mn, Ga₂O₃:Eu and CaAl₂O₄:Eu. Sulfide phosphors include: SrS:Cu, ZnS:Mn, BaAl₂S₄:Eu, and BaAl₄S₇:Eu. Where sulfide phosphors are utilized for the EL phosphor layer 14, the sulfide phosphors may be sealed on the front and the sides of the EL chip 10. The sealing layer may vary in thickness according to an embodiment of the invention. Indeed, the sealing layer may be a thin glass coating, according to an embodiment of the invention.

During operation of the EL chip 10, as illustrated in FIGS. 1 and 2 (and 3) the EL chip 10 will be electrically connected to a row voltage and a column voltage using bottom electrode layers 16 and 18. For example, bottom electrode layer 16 may be connected to a row voltage while bottom electrode layer 18 may be connected to a column voltage, according to an embodiment of the invention. Because the row voltage and column voltage connections to the bottom electrode layers 16 and 18 may need to be routed over each other, the row and column connections may be provided as crossovers on a flexible circuit material supporting the EL chip 10. It will be appreciated that the flexible circuit material may be a 2-sided Kapton board with row connections on a first side of the board and column connections on a second side opposite the first side. Vias may be utilized to connect one of the bottom electrode layers 16 and 18 to the row connection or the column connection provided on the Kapton board. In addition, solder bumps, solder paste, conductive epoxy, or other conductive adhesive may be utilized to connect the bottom electrode layers 16 and 18 to the row connection or the column connection provided by the Kapton board. Furthermore, it will also be appreciated that stiffeners, perhaps metal stiffeners, may be applied to a back side of the Kapton board without departing from embodiments of the invention.

According to a first embodiment of the invention, the EL chip 10 may be operated in a push-pull configuration. With a push-pull configuration, equal and opposite voltages may be applied to the bottom electrode layers 16 and 18, to provide a virtual ground (e.g., a substantially zero potential) at the conductive layer 12. According to a second embodiment of the invention, the EL chip 10 may be operated as if at least two discrete EL devices were connected in series so that the voltage across conductive layer 12 may be shared between two EL devices. In this second embodiment, the row voltages applied to the bottom electrode layer 16 may be driven at twice the typical row voltage (e.g., 160V up to 320V) used for discrete EL devices with top and bottom electrodes, but at half the current. By applying twice the typical row voltages to the bottom electrode layer 16, the EL chip 10 capacitance may be about four (4) times smaller than for discrete EL devices with top and bottom electrodes since with both electrodes on a single side, the EL chip 10 includes essentially two half-size discrete EL devices in series.

The lowered capacitance may enable an increase in the refresh rate by a factor of four (4), as refresh rates may be fundamentally limited by high EL panel capacitance. Furthermore, this increased refresh rate may decrease the required column or modulation voltages applied to the bottom electrode layer 18 by a factor of two (2). In particular, by increasing the refresh rate by a factor of 4, the modulation voltages normally decrease by a factor of 4. However, because the series connection of essentially two half-size discrete EL devices doubles the drive voltage applied to bottom electrode layer 16, there may be a net decrease in modulation voltage applied to bottom electrode layer 18 by a factor of 2.

As indicated above, the row voltages applied to bottom electrode layer 16 are doubled since the row voltages are normally set according to the threshold voltage of the EL element or nixel. If the row voltages need to be reduced, the thickness of the phosphor layer 14 may be reduced. However, the higher row voltages may not be problematic for several reasons. For example, there are only 1080 rows versus 5760 columns in a single scan full HD display, and only 540 rows versus 11,520 columns in a dual scan HD display.

Further, a reduction in column voltages applied to bottom electrode layer 18 may compensate for higher row voltages applied to bottom electrode layer 16. Row driver voltage requirements may be reduced by floating the row drivers, which is commonly used in plasma displays. Furthermore, increasing refresh rate makes grayscale easier to implement and further provides more control over pixel refresh rates.

Therefore, the modular EL chips supported on one side by a thin glass substrate, with the electrical contacts (e.g., electrodes) formed on one side thereof may be assembled into an electroluminescent matrix-addressed display comprising a plurality of electroluminescent pixels arranged in a 2-dimensional array, each pixel being electrically connected across a unique combination of one of conductive row electrodes and one of conductive column electrodes, with the row connected to the first rear electrode of the electroluminescent pixel and the column connected to the second rear electrode of the electroluminescent pixel. Thus, embodiments of the invention provide a discrete electroluminescent display module, an EL element or nixel, having both electrical contacts on the same side thereof, that can be individually manufactured, tested, sorted and selectively positioned to make an ELD in accordance with the invention.

The methods of the invention can produce a flexible display with scalable dimensions that avoids the limitations imposed by prior art processes that employ glass to provide structure. Exemplary embodiments are included herein as examples of an invention that can be variably implemented and practiced, and as such, are not considered to be limitations, since modifications and alternative embodiments will be apparent to those skilled in the art. Thus, the invention encompasses all the embodiments and their equivalents that fall within the scope of the appended claims.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

What is claimed is:

1. An electroluminescent display element, comprising at least one pixel, each pixel comprising:
two light emitting regions, each of said at least two light emitting regions including
a dielectric layer having an upper surface and a lower surface;
a top conductive layer having an upper surface and a lower surface, wherein the top conductive layer and the dielectric layer are positioned opposite one another so that the lower surface of the top conductive layer faces the upper surface of the dielectric layer;
a phosphor layer, wherein the phosphor layer is arranged between, and is in physical contact with, the dielectric layer and the top conductive layer;
a bottom conductive layer having an upper surface and a lower surface, wherein the bottom conductive layer and the dielectric layer are positioned opposite one another so that the upper surface of the bottom conductive layer faces, and is in physical contact with, the lower surface of the dielectric layer, and wherein the bottom conductive layer forms a first bottom electrode and a second bottom electrode; and
said at least two light emitting regions mounted on a single glass plate with a lower surface of the glass plate in physical contact with the upper surface of the top conductive layer of all of said at least two pixels.

2. The electroluminescent display element of claim 1, including a layer of a bonding agent located between the glass plate and said at least two light emitting regions for bonding the at least two light emitting regions to said glass plate.

3. The electroluminescent display element of claim 1, wherein said light emitting regions form three pixels with six light emitting regions each pixel emitting in a different region of the visible light spectrum to give a multicolored electroluminescent display element.

4. The electroluminescent display element of claim 3, wherein one pixel of said three pixel electroluminescent display element emits in a red portion of the visible spectrum, one emits in a green portion of the visible spectrum portion and one emits in a blue portion of the visible spectrum to give an RGB electroluminescent display element.

5. A method for fabricating an electroluminescent display element, comprising the steps of:
a) providing a dielectric layer having an upper surface and a lower surface;
b) depositing a phosphor layer over the upper surface of the dielectric layer;
c) arranging a top conductive layer such that the top conductive layer and the dielectric layer sandwich the phosphor layer;
d) bonding a glass plate to an upper surface of the top conductive layer using a layer of bonding agent to affix the glass plate to the top conductive layer;
e) grinding the lower surface of the dielectric layer to give a dielectric layer with a desired thickness after the glass plate is bonded to the top conductive layer; and
f) arranging a bottom conductive layer on the lower surface of the dielectric layer such that the bottom conductive layer and the phosphor layer sandwich the dielectric layer, wherein the bottom conductive layer forms a first bottom electrode and a second bottom electrode.

6. The method of claim 5, wherein the dielectric layer has a thickness in a range from about 50 to about 200 microns after being ground.

7. The method of claim 5, wherein the glass plate has a thickness in a range from about 50 to about 1000 microns.

8. The method of claim 6, wherein the glass plate has a thickness in a range from about 50 to about 1000 microns.

9. The method of claim 5, wherein said phosphor layers are selected from the group of sulphide phosphors, oxide phosphors, and any combination thereof.

10. A method for fabricating an electroluminescent display element, comprising:
a) providing a glass plate having an upper surface and a lower surface;
b) depositing an upper conductive layer on the lower surface of the glass plate;
c) depositing a phosphor layer over the upper conductive layer;
d) depositing a dielectric layer over the phosphor layer;
e) depositing a bottom conductive layer on a lower surface of the dielectric layer wherein the bottom conductive layer forms a first bottom electrode and a second bottom electrode.

11. The method of claim 10, wherein the dielectric layer has a thickness in a range from about 0.2 microns to about 50 microns.

12. The method of claim 10, wherein the glass plate has a thickness in a range from about 500 to about 1100 microns.

13. The method of claim 11, wherein the glass plate has a thickness in a range from about 500 to about 1100 microns.

14. The method of claim 10, wherein said phosphor layers are selected from the group of sulphide phosphors, oxide phosphors, and any combination thereof.
